(19) United States
(12) Patent Application Publication
(10) Pub. No.: US 2005/0133764 A1
(43) Pub. Date: Jun. 23, 2005

(54) Latex dispersions containing a hydroxyl functional group and a carboxylic functional group and their use for the manufacture of coatings

(76) Inventors: Mathieu Joanicot, Chatenay Malabry (FR); Bruno Langlois, Sainte Genevieve Des Bois (FR); Theresa Michael, Levallois Perret (FR); Joel Richard, Blou (FR)

Correspondence Address: Rhodia Inc., CN 7500, 259 Propspect Plains Road, CRANBURY, NJ, 08512, US

(21) Appl. No.: 11/062,092

(22) Filed: Feb. 18, 2005

Related U.S. Application Data
(63) Continuation of application No. 09/905,121, filed on Jul. 13, 2001.
Application No. 09/905,121 is a continuation of application No. 09/276,031, filed on Mar. 25, 1999, now abandoned.
Application No. 09/276,031 is a continuation of application No. 08/638,032, filed on Apr. 26, 1996, now abandoned.

(30) Foreign Application Priority Data
Apr. 28, 1995 (FR) 95 05123

(51) Int. Cl. B01F 1/00

(52) U.S. Cl. 252/364

(57) ABSTRACT

The present invention relates to dispersions in an aqueous phase of forming coatings after curing. The composition which can be used for paint and varnish, made up of a dispersion comprising at least one aqueous phase and a population A of particles of (co)polymer(s) whose size is between 10 and 1000 nanometres, in which the particles have an accessible acidic (advantageously carboxylic) functional group content of between 0.2 and 1.2 milliequivalents/gram of solid matter and have an accessible alcoholic functional group content of between 0.3 and 1.5 milliequivalents/gram. Application to paint.

The present invention relates to dispersions in an aqueous phase which are capable of forming, after curing, quality coatings, which make it possible to reduce and even eliminate the use of solvent(s) in paints.

In the field of paints and varnishes alcoholic derivatives are widely employed for condensing them with other functional groups and especially with isocyanate functional groups, whether masked or otherwise. However, two problems remain incompletely solved to date, namely the use of organic solvents, the presence of which is considered to be toxic to higher mammals and detrimental to the environment, and the need to market products which are non volatile at the temperatures of use.

Another aspect of the problems to be solved in the paint and varnish industry lies in the often high cost of compounds containing complex functional groups such as isocyanates, masked or otherwise.

However, it is difficult to abandon these complex functionalities because they give rise to use properties which are often remarkable. It is appropriate to recall here that the ability of the compositions to form paints or varnishes is evaluated according to the qualities of the coats of which they are the precursors. Among the essential qualities of a coat of varnish it is appropriate to mention the mechanical properties and the properties of behaviour towards solvents. Among the mechanical properties the Persoz hardness is a very important factor. This is why one of the objectives of the present invention is to provide compositions in which the main solvent consists of an aqueous phase.

Another objective of the present invention is to provide a composition which, by itself or in combination with others, produces coatings exhibiting good mechanical properties and especially a good Persoz hardness.

Another objective of the present invention is to provide a composition of the above type which exhibits good resistance to solvents.

These objectives, and others which will appear later, are obtained by means of a composition which can be used for paint and varnish, made up of a dispersion comprising at least one aqueous phase and a population A of particles of (co)polymer(s) whose size is between 10 and 1000 nanometres, the particles having an accessible acidic (advantageously carboxylic) functional group content of between 0.2 and 1.2 and preferably between 0.4 and 1 milliequivalents/gram solid matter and that they have an accessible alcoholic functional group content of between 0.3 and 1.5, an preferably between 0.4 and 1.2 milliequivalents/gram.

By acidic functional group, it shall be understood functional group that in the neutral state is acidic. e.g. the carboxylic group is hold as an acidic functional group even if in the carboxylate state.

The carboxylic functional groups which are at most 5 nanometres from the surface and the hydroxyl (alcoholic) functional groups which are at most 10 nanometres from the surface [particle—continuous (in most cases aqueous) phase interface in the case of latices] are considered to be accessible.

The solids content of these latices is advantageously between 10 and 80% and preferably between 10 and 60% on a mass basis.

The acidic functional groups of the particles of the population A are preferably weak acidic functional groups whose pKₐ is at most 2, preferably at most 3. Among the acidic functional groups which are satisfactory it is preferable to employ carboxylic functional groups. However, the use of phosphonic functional groups can be envisaged.

The acidic functional groups—at least those which are capable of exchanging with the medium—are advantageously in the form of salts, so as to form easily dissociable salts. Among the cations which are satisfactory, the alkali and alkaline-earth metal ones may be mentioned, especially those of a period which is at least equal to the 3rd period of the Periodic Classification of the elements.

The preferred ones are the alkali metals and the cations which are closely related to them. Cations of the ammonium or phosphonium type, in particular the tri- and above all the tetraalkylated ones may be mentioned in particular.

In the present description the particle size characteristics often refer to notations of the dₙ type, where n is a number from 1 to 99; this notation is well known in many technical fields but is a little rarer in chemistry, so it may be useful to give a reminder of its meaning. This notation represents the particle size such that n % (by weight, or more precisely on a mass basis, since weight is not a quantity of matter but a force) of the particles are smaller than or equal to the said size.

It may be desirable for the population of these particles to have a dispersity of the population A ([d₉₀-d₁₀]/d₉₀) of between 0 and ¼.

The polymers of the population A generally originate from a polymerization between various unsaturated monomers (unsaturation of ethylenic type, advantageously activated by:
an immaterial monomer, or a mixture of monomers, which is nonionic and which does not contain an alcoholic functional group,
an alcoholic monomer, or a mixture of monomers, containing an alcoholic functional group,
an acidic monomer, or a mixture of monomers, containing an acidic functional group which is free or in the form of one of its salts.

As immaterial monomer there may be mentioned: monomers of ethylenic type, the main paradigms of which are isoprene, 1,3-butadiene, vinylidene chloride and acrylonitrile, monomers of vinylaromatic type, the chief representatives of which may be mentioned, by way of paradigm, namely styrene, bromostyrene, alphamethylstyrene, ethylstyrene, vinyltoluene, chlorostyrene or vinylnaphthalene, and monomers of acrylic type, among which there may be mentioned, by way of paradigm, esters of acrylic or methacrylic acid and esters of ethylenic acid containing 4 or 5 carbons.

As alcoholic monomer there may be mentioned: phenols containing an ethylenic functional group activated by an aromatic nucleus, and esters, especially acrylic ones, of a polyol, especially of a diol, in which at least one of the alcoholic functional groups is free. It is also possible to mention amides substituted by an alkyl radical bearing an alcoholic functional group, such as, for example, the acrylamide of ethanolamine.

As acidic monomer there may be mentioned: all the acids containing an activated bond, in particular the acids of the acrylic series, which may be substituted once or more times on the carbon atoms in an alpha or beta position to the carboxylic functional group.

It is also possible to envisage diacids containing an activated double bond, such as, for example, fumaric and itaconic acids, products of their substitution and their isomers. Symmetric or asymmetric anhydrides, internal or otherwise, of the abovementioned acids may also be mentioned as “acidic” monomer, instead of the acids or their salts.

It is also appropriate to note that a monoester of a diacid with a diol in which only one functional group is esterified makes it possible to produce the grafting onto the polymer of an alcoholic functional group with an acidic functional group, and can therefore replace the two monomers mentioned last, namely the alcoholic monomers and the acidic monomers.

It is preferable that the -ol functional groups should be aliphatic, preferably primary, alcohols.

Thus, according to the present invention, it is preferable that the units should originate from the monomers clarified above.

It follows that the (co)polymer particles originate from a copolymerization between at least one free acid containing an activated ethylenic bond and at least one free alcohol containing an activated ethylenic functional group.

By way of illustration (or more precisely of paradigm) the following (co)monomers may be mentioned more particularly:

By way of vinyl and acrylic monomers which are suitable for the invention there may be mentioned more particularly those derived from styrene, from acrylic acid, from acrylic esters, methacrylic acid, monobenzyl maleate, 2-vinylpyridine, styrene methylsulphonate, chloromethylstyrene, hydroxypropyl methacrylate, hydroxybutyl acrylate, hydroxyethyl acrylate, acrylonitrile and/or acrolein.

These monomers are employed by themselves or mixed with each other in any proportion, or else mixed with another copolymerizable monomer chosen from those mentioned above.

The polymer particles may be obtained by making use of any polymerization technique such as conventional emulsion or microemulsion polymerization or, if appropriate, by polymerization in an organic medium. These techniques, which are familiar to a person skilled in the art, will not be recalled here.

The particles forming the latex which bears (a) functional group(s) according to the invention are hydrophobic and advantageously have a size (d₉₀) which is generally between 0.01 micrometre and 10 micrometres and preferably at most 5 micrometres or even 2 micrometres. They are calibrated, monodisperse and are present in the latex in a quantity which varies between 0.2 and 65% by weight of the total weight of the latex.

The average molecular mass (M_{w} determined by gel permeation chromatography) of the polymers constituting the particles of the population A is advantageously between 5×10⁴ and 5×10⁶, preferably 10⁵ and 2×10⁶.

The alcoholic functional groups or the acidic, preferably carboxylic, functional groups may also be obtained by hydrolysis of alcohol-forming functional groups (ester, ether, halide etc) or of acid-forming functional groups (ester, anhydride, acid chloride, amide, nitrile etc).

The distribution between the various types of units advantageously corresponds to the following rules:

The content of the unit originating from the monomer consisting of the said free alcohol containing an activated ethylenic functional group, and related to the totality of the units of any kind, is advantageously between 3 and 15%, preferably between 4 and 10% (mole or equivalent).

According to an advantageous method of the present invention the unit originates from an ester, of an alpha-ethylenic acid, with a diol in which one of the alcohol functional groups remains unesterified. The said diol is advantageously an ω, ω′-diol, advantageously chosen from 1,3-propanediol and glycol.

It is desirable that the said alpha-ethylenic acid should be an optionally substituted acrylic acid.

According to a preferred method of the present invention the content of unit originating from a free carboxylic acid (or in the form of one of its salts) and related to the totality of the units of any kind, is between 2 and 10% (mole).

For economic reasons it is often advantageous that the said free acid should be an optionally monosubstituted acrylic acid or one of its salts.

The particles originating from the present invention may consist of two separate polymers, the first forming the core and the second forming the periphery. This type of particle can be obtained by epipolymerization [in which a latex seed is covered by surface polymerization (epipolymerization, sometimes referred to as overpolymerization)] of a different polymer. The core is sometimes called a seed, by analogy with the crystallization phenomenon. In this case only the second polymer, that is to say the surface polymer, corresponds to the constraints of concentration of the different functional groups according to the present invention.

The latices obtained may have an emulsifier content of at most 2%, advantageously of at most 1% by weight.

The compositions according to the present invention are generally employed with blocked or unblocked isocyanates. With these isocyanates they may constitute complete compositions in which the two functional groups which condense with one another are encountered again, namely the polyols and the isocyanates.

Thus, according to the present invention, the compositions may additionally contain isocyanates. These isocyanates may be soluble and may be dissolved in the aqueous phase or, and this is the more general case, may be insoluble, in which case they are advantageously in the form of a population B of particles bearing isocyanate functional groups, in most cases masked ones. These particles are such that they form an advantageously monodisperse emulsion whose particle size and dispersity are close to those of the latex which it is intended to polycondense. The preferred emulsions are those described in the International Patent Application published under No. 94/22935.

By way of indication, to give coatings of good quality, it is desirable that the mass ratio of the populations A and B should be such that the ratio of the alcohol functional groups to the isocyanate functional groups is between 0.1 and 10, advantageously between 0.3 and 5.

According to the present invention it is particularly advantageous to employ latices bearing an advantageously blocked isocyanate functional group for forming coatings. The latices referred to in PCT Patent Application No. WO 94/13712, published on 23 Jun. 1994 under this number may be mentioned in particular.

According to the present invention the latices or, more precisely, the particles constituting the latex have an isocyanate, preferably masked, functional group content of between 0.05 and 1 milliequivalent/gram of particles of population B.

According to an advantageous embodiment of the present invention the particles of population A and B coincide, in other words the particles form only a single population and bear the 3 functional groups on the same particle, namely an advantageously blocked isocyanate functional group, an alcohol functional group and an acidic functional group which is free or in the form of one of its salts.

Thus, the populations A and B coincide to constitute a particle population comprising free carboxylic functional groups, free alcohol functional groups and masked isocyanate functional groups at the same time. In this case self-crosslinkable dispersions are obtained where the particles are concerned, since the latter simultaneously contain the functional groups which are necessary for the crosslinking.

The presence of a carboxylic functional group which is free (in acid form) or in salt form gives, on the one hand, the dispersion a remarkable physical stability and, on the other hand, significantly promotes the formation of a paint or of a varnish by crosslinking polycondensation. This property is valid for all the implementations of the present invention. If one returns to the particles simultaneously bearing the abovementioned 3 functional groups, it may be noted that it is preferable that they, or at least their surface coat, correspond to the conditions set out below:
the ratio, (equivalent), of the masked isocyanate to the alcohol functional groups (NCO/OH) is between 0.1 and 10, preferably between 0.2 and 4;
the ratio, (equivalent), of the alcohol functional groups to the carboxylic functional groups (OH/COOH) is between 0.2 and 5;
the ratio (equivalent), of the isocyanate to the carboxylic functional groups (NCO/COOH) is between 0.1 and 10, preferably between 0.2 and 4.

To obtain good stability of the latex according to the present invention it is desirable that the hydrogen potential, or pH, should be between 4 and 9, preferably between 5 and 8.

The compositions according to the present invention advantageously have all or part of the additives such as stabilizing pigments necessary for the constitution of the varnishes and/or paints.

More particularly, according to this embodiment of the present invention, in order to obtain satisfactory results it is desirable that the content of the blocked isocyanate functional group(s) in the (co)polymer (latex or epilayer in the case of an epipolymerization) should be at least 5×10⁻², advantageously 0.1, preferably 0.2 functional groups, more preferably 0.3 functional groups per kilogram (equivalents per kilogram). There is no upper limit, except for an economic one; it is desirable nevertheless that the (mass) percentage of the, or of the mixture of, monomer(s) bearing masked isocyanates should not exceed 75% of the mass weight of latex.

There is no upper, except economic, limit in the case where use is made of an HMDI [hexamethylene diisocyanate=OCN—(CH₂)₆—NCO] trimer, sold under the name Tolonate®, with approximately two isocyanate functional groups which are masked by a methyl ethyl ketoxime protection and a hydroxyethyl acrylate branch grafted onto the last isocyanate functional group.

A value of 0.1 functional group per kilogram corresponds approximately to an incorporation of 5 mass % of the monomer of formula I into the latex.

The compositions according to the present invention may comprise demasking catalysts which are known per se for assisting in the demasking of the chosen functional group. Tin and zinc compounds, such as dialkyltin dicarboxylate, zinc carboxylate and tin beta-diketonate may be mentioned in particular.

They may also include a coloured base, especially of the type comprising a pigment and titanium dioxide.

The masking agents which can be employed are agents that are known per se but which, of course, exhibit the property of forming stable derivatives in the conditions of synthesis and of storage of the latices. When the masking agent is chosen it is appropriate to take into account the surprising property of particles associating an acidic and alcohol functional group according to the present invention, of releasing the isocyanates at a temperature which is lower than usual (approximately 20° C. below).

Among the masking groups, groups containing mobile hydrogen may be chosen, whose pKₐ is at most 14, advantageously 12, preferably 10 and more preferably 8.

The higher the pKₐ, the more desirable it is that the masking agent should be volatile (provided that this volatile character does not impair the qualities of the possible paints).

The masking agents are chosen so that the emulsion is stable at its storage temperature.

Among the chemical functional groups capable of masking the isocyanates the following functional groups may be mentioned by way of examples, or rather of paradigms:
alcohols (including vinyl alcohols and phenols) and thiols;
oximes (the most common of which is methylethylketoxime, called “meko”);
hydroxylamines
acids;
amides and especially imides;
beta-diketones;
pyrazoles, especially those obtained by the action of beta-diketones on hydrazine.

The present invention also relates to a process for the preparation of latices bearing (an) isocyanate functional group(s), according to the following techniques:
the introduction, in the course of polymerization of the monomer(s) constituting the latex particles, of a monomer according to the invention in suspension in a fraction of, or of one of, the monomer(s) and
epipolymerization, which consists of a synthesis of the type sometimes referred to as “core-shell”: a latex seed is epipolymerized with the (co)monomer(s) in the presence of initiator and of a surfactant. The monomer according to the invention, in suspension in a fraction of (co)monomer(s), is introduced at the end of polymerization so as to obtain latex beads of a precise and narrowly distributed particle size, in which the monomer according to the invention is grafted at a more or less great distance from the core of the particles.

In general, the polymerization temperature is between 30 and 90° C., advantageously between 40 and 80° C. In general the duration is between 1 and 10, advantageously between 4 and 8, hours.

After polymerization the latex is treated by the addition of a redox system and by distillation, optionally under vacuum, in order to remove any trace of residual monomers from it, and is then purified.

The polymer constituting the latex advantageously contains from 1 to 50% by weight, advantageously 3 to 25% by weight, of at least one of the monomer such as defined in PCT Patent Application No. WO 94/13712.

Another subject of the present invention is the use of the compositions according to the present invention for manufacturing coatings.

It is also aimed at a process for the preparation of a coating comprising at least one stage of application onto a support of a composition according to the present invention.

When the said compositions comprise at least one masked isocyanate functional group the process comprises a subsequent stage of curing at a temperature of between 120 and 200° C.

The following nonlimiting examples illustrate the invention:

### EXAMPLE 1

Preparation of a control (C) carboxylated acrylic copolymer latex containing no blocked isocyanate groups.

2.28 kg of deionized water are mixed in a 15-I vessel with 98 g of an aqueous solution of sodium dodecylbenzenesulphonate (NaDBS) at a concentration of 23% by weight. A mixture of the following acrylic comonomers is introduced into this solution with stirring:
2.25 kg of methyl methacrylate (MMA),
2.025 kg of butyl acrylate (BuA),
225 g of acrylic acid (AA).

The mixture obtained is emulsified with the aid of an Ultra-Turax homogenizer (marketed by Prolabo) for 5 minutes at 20 000 revolutions/minute. A preemulsion of the acrylic monomers, which is stable with time, is thus obtained.

4 kg of deionized water are introduced into a 15-litre stainless steel reactor fitted with a stirrer and are heated to 80° C. with stirring. The following are added next:
250 g of the preemulsion prepared above,
250 g of an aqueous solution containing 13.5 g of ammonium persulphate initiator.

There is a wait of 15 minutes for the initiation of the reaction to take place and the remainder of the preemulsion, that is 6.53 kg, is then added over a period of 4 hours. 150 g of water are added next and the mixture is left to cook at 81° C. for 1 hour. It is then cooled to 60° C. and 6.4 g of tert-butyl hydroperoxide and 2.7 g of Na₂S₂O₅ are added. The temperature is maintained at 60° C. for 30 minutes and the mixture is then cooled to ambient temperature. It is neutralized with a 10% dilute sodium hydroxide solution. A latex is thus obtained which exhibits the following characteristics:
solids content of 39.8 mass %,
pH=7.3,
RTV-DV 11 Brookfield viscosity (50 rev/min): 25 centipoises,
particle size: 0.435 micrometres,
grain content (measured on a 50-lm filter):
80 ppm.

### EXAMPLE 2

Preparation of a reactive latex (R) of carboxylated acrylic copolymer containing 7% by weight of the functional acrylic ester monomer AEHDB (See examples PCT Patent Application No. WO 94/13712, published on 23 Jun. 1994 under this number) bearing reactive blocked isocyanate functional groups (2.3 mmol of reactive NCO per gram of monomer).

2.3 kg of deionized water are mixed in a 15-I vessel with 97.6 g of an aqueous solution of sodium dodecylbenzenesulphonate (NaDBS) at a concentration of 23% by weight. A mixture of the following acrylic comonomers is introduced into this solution with stirring:
1.93 kg of methyl methacrylate (MMA),
2.025 kg of butyl acrylate (BuA),
225 g of acrylic acid (AA),
524 g of a mixture of AEHDB/BuA containing 60% by weight of the functional monomer (that is 0.72 mol of total reactive NCO).

The mixture obtained is emulsified with the aid of an Ultra-Turax homogenizer (marketed by Prolabo) for 5 minutes at 20 000 revolutions/minute. A preemulsion of the acrylic monomers, which is stable with time, is thus obtained.

4 kg of deionized water are introduced into a 15-litre stainless steel reactor fitted with a stirrer and are heated to 80° C. with stirring. The following are added next:
200 g of the preemulsion prepared above,
250 g of an aqueous solution containing
13.5 g of ammonium persulphate initiator.

There is a wait of 15 minutes for the initiation of the reaction to take place and the remainder of the preemulsion, that is 6.8 kg, is then added over a period of 4 hours. 300 g of water are added next and the mixture is left to cook at 81° C. for 1 hour. It is then cooled to 60° C. and 4.5 g of tert-butyl hydroperoxide and 2.7 g of Na₂S₂O are added. The temperature is maintained at 60° C. for 30 minutes and the mixture is then cooled to ambient temperature. It is neutralized with a 10% dilute sodium hydroxide solution. A latex is thus obtained which exhibits the following characteristics:
solids content of 40.3 mass %,
pH=7.2,
RTV-DV 11 Brookfield viscosity (50 rev/min): 25 centipoises,
particle size: 0.690 micrometres,
grain content (measured on a 50-μm filter): 100 ppm.

### EXAMPLE 3

Preparation of a latex (H) of carboxylated acrylic copolymer containing 5% by weight of the hydroxylated acrylic ester monomer (hydroxyethyl methacrylate or HEMA) bearing crosslinking —OH functional groups (7.7 mmol of —OH/g of polymer).

The procedure is exactly the same as in Example 2 in the two stages of preemulsion and polymerization, but with the following composition for the preemulsion of the acrylic comonomers:
2.2 kg of methyl methacrylate (MMA),
2 kg of butyl acrylate (BuA),
248 g of acrylic acid (AA),
247 g of hydroxyethyl methacrylate monomer (HEMA).

After polymerization and cooling a latex is thus obtained which exhibits the following characteristics:
solids content of 39.5 mass %,
pH=7.2,
RTV-DV 11 Brookfield viscosity (50 rev/min at 25° C.): 40 centipoises,
particle size: 0.71 micrometres,
grain content (measured on a 50-μm filter):
120 ppm.

### EXAMPLE 4

Preparation of a self-crosslinkable latex (SC1) of carboxylated acrylic copolymer containing, at the same time, 5% by weight of the hydroxylated acrylic ester monomer (hydroxyethyl methacrylate or HEMA) bearing crosslinking OH functional groups (7.7 mmol of —OH/g of monomer) and 7% by weight of the functional acrylic ester monomer AEHDB bearing reactive blocked isocyanate functional groups (2.3 mmol of reactive NCO per gram of monomer).

The procedure is exactly the same as in Examples 2 and 3 in the two stages of preemulsion and polymerization, but with the following composition for the preemulsion of the acrylic comonomers:
2 kg of methyl methacrylate (MMA),
1.66 kg of butyl acrylate (BuA),
235 g of acrylic acid (AA),
235 g of hydroxyethyl methacrylate monomer (HEMA),
548 g of a mixture of AEHDB/BuA containing
60% by weight of the functional monomer
(that is 0.75 mol of total reactive NCO).

After polymerization and cooling a latex is thus obtained which exhibits the following characteristics:
solids content of 40.4 mass %,
pH=7.2,
RTV-DV 11 Brookfield viscosity (50 rev/min at 25° C.): 43 centipoises,
particle size: 0.830 micrometres,
grain content (measured on a 50-μm filter):
150 ppm.

### EXAMPLE 5

Preparation of a self-crosslinkable latex (SC2) of acrylic copolymer containing, at the same time, 10% by weight of the hydroxylated acrylic ester monomer (hydroxyethyl methacrylate or HMEA) bearing crosslinking —OH functional groups (7.7 mmol of —OH/g of monomer) and 7% by weight of the functional acrylic ester monomer AEHDB bearing reactive blocked isocyanate functional groups (2.3 mmol of reactive NCO per gram of monomer).

The procedure is exactly the same as in Examples 2 and 3 in the two stages of preemulsion and polymerization, but with the following composition for the preemulsion of the acrylic comonomers:
1.93 kg of methyl methacrylate (MMA),
1.50 kg of butyl acrylate (BuA),
235 g of acrylic acid (AA),
470 g of hydroxyethyl methacrylate monomer (HEMA),
548 g of a mixture of AEHDB/BuA containing 60% by weight of the functional monomer (that is 0.75 mol of total reactive NCO).

After polymerization and cooling a latex is thus obtained which exhibits the following characteristics:
solids content of 40.5 mass %,
pH=7.4,
RTV-DV 11 Brookfield viscosity (50 rev/min
at 25° C.): 46 centipoises,
particle size: 0.650 micrometres,
grain content (measured on a 50-μm filter): 150 ppm.

### EXAMPLE 6

Formulations and evaluation of the varnishes formulated from the aqueous dispersions of the polymers C, R, H, SC1, SC2.

a). Formulations: The latices prepared in Examples 1 to 5 above are introduced into the following varnish formulations:

| Formulation No. | Composition of the varnish formulations |
|---|---|
| 1 | Latex C (0.70 meq. COOH/g of varnish) |
| 2 | Latex C + blocked Tolonate |
| | emulsion (*) |
| | (0.55 meq. COOH + 0.85 meq. reactive |
| | NCO/g of varnish) |
| 3 | Latex R |
| | (0.70 meq. COOH + 0.16 meq. reactive |
| | NCO/g of varnish) |
| 4 | Latex H |
| | (0.70 meq. COOH + 0.38 meq. OH/g of |
| | varnish) |
| 5 | Latex H + blocked Tolonate |
| | emulsion (*) |
| | (0.55 meq. COOH + 0.31 meq. OH + 0.85 meq. |
| | reactive NCO/g of varnish) |
| 6 | Latex SC1 |
| | (0.70 meq. COOH + 0.38 meq. OH + 0.16 meq. |
| | reactive NCO/g of varnish) |
| 7 | Latex SC2 |
| | (0.70 meq. COOH + 0.76 meq. OH + 0.16 meq. |
| | reactive NCO/g of varnish) |

In formulations 2 and 5, 25% by weight of blocked Tolonate HDT (methyl ethyl ketoxime or MEKO) were introduced in the form of an aqueous emulsion with a solids content of 80 mass %, a mean diameter of 1 μm, stabilized with a nonionic surfactant (polyoxyethylenated nonyl phenol of Antarox 461 P type).

The utilization values of these aqueous formulations are compared with each other, and some are compared with those which are obtained with a base formulation (B) in a solvent medium: blocked Tolonate HDT+Synaqua 3510 WL polyol (blocked NCO/OH ratio=1) after curing at 160° C. for 30 min.

b) Evaluation Methods

The appearance of some varnishes was evaluated by forming films on glass plates, under a moist thickness of 100 μm. The drying of the films took place for 8 hours at a temperature of 50° C. A cure is then performed for 1 hour at 160° C. The scattering or transparent homogeneous nature of the films thus formed is evaluated.

The Persoz hardness measurements are performed by virtue of the Gardco HA 5854 hardness evaluation pendulum (number of oscillations) on varnishes deposited on an aluminium plate, under a wet thickness of 300 μm. The drying of the films took place for 8 hours at a temperature of 50° C. A cure is then performed for 30 minutes at 140° C. The varnishes obtained are next cooled to 25° C. and characterized by virtue of the Persoz pendulum, the number of oscillations of which is measured. The varnishes are also characterized in respect of Persoz hardness before the samples are cured (only drying at 50° C.). Persoz hardness measurements are also performed on some samples of varnishes prepared on glass supports (see above).

The water uptake and the swelling in solvent (tetrahydrofuran/methyl ethyl ketone mixture in proportions of 90/10) are evaluated by a method of weighing samples of thick films (1 mm) prepared by dehydration of the formulations in silicone moulds according to the same process as that described above (drying of the films for 8 hours at 50° C., then curing for 30 minutes at 140° C.).

The water uptake and swelling manipulations are performed at ambient temperature. The water uptake is expressed in the form of the change in weight of the sample, as a mass percentage of water absorbed at equilibrium (approximately 4 hours). The swelling is expressed in the form of the ratio of the weight of the sample swollen with the solvent at equilibrium (approximately 4 hours) to the weight of the same sample when dry.

The elongation and the stress at break are evaluated by virtue of a tensometer (Adamel-Lhomargy DY 15) on samples of films 4 mm in width and 10 mm in length, prepared by dehydration of the formulations in silicone moulds according to the same process as that described above (drying of the films for 8 hours at 50° C., then curing for 30 minutes at 140° C.). The elongation at break is expressed as a percentage of the initial length of the sample and the stress at break in MPa.

Young's modulus of the varnishes is measured from the slope at the origin of tensile curves (Adamel-Lhomargy DY 15 tensometer) which represent the applied stress as a function of the elongation of the film.

The kinetics of crosslinking of the varnishes are studied in a small-deformation regime (amplitude<0.3%) using the dynamic mechanical analysis (DMA) method on films 0.5 mm in thickness, 4 mm in width and 10 mm in length at 25° C. on the Perkin-Elmer DMA 7 instrument. The test pieces are prepared by dehydration of the formulations in silicone moulds according to the same process as that described above (drying of the films for 8 hours at 50° C.). Then the change in the elastic modulus E′ as a function of time is followed using DMA during the curing of the varnishes at 160° C.

### EXAMPLE 7

Comparison of the performance of the formulated varnishes, determined according to the experimental procedures described in Example 6.

a) Mechanical Characteristics:

| | Persoz | Persoz | Persoz | Break | Break | Young's |
|---|---|---|---|---|---|---|
| | hardness | hardness | hardness | elongation | stress | modulus |
| | before cure | after cure | after cure | (%) | (MPa) | (GPa) |
| Formulation | (on Al) | (on Al) | (on glass) | after cure | after cure | after cure |
| No. | (n.o.*)(140 C.) | (n.o.*)(140 C.) | (n.o.*)(160 C.) | (140° C.) | (140° C.) | (140° C.) |
| B | — | — | 428 | — | — | — |
| 1 | 170 | 170 | 230 | 340 | 85 | 15.5 |
| 2 | 120 | 180 | — | 445 | 45 | 2 |
| 3 | 120 | 130 | — | — | 75 | 7 |
| 4 | 145 | 170 | 370 | 340 | 105 | 15.5 |
| 5 | 150 | 185 | — | 205 | 50 | 13 |
| 6 | 180 | 200 | 415 | 340 | 85 | 11 |
| 7 | — | — | 480 | — | — | — |

Formulation 6 yields the highest Persoz hardness on metal. It also has a very high Persoz hardness on glass, equivalent to that yielded by the system in a solvent phase. Formulation 7 produces a Persoz hardness which is higher than that of the solvent system, on glass. The highest stresses at break (>70 MPa) are obtained with the systems based on latices alone (of R, H or SC type) in the case of which all of the functional groups (—COOH, —OH and —NCO) are contained in a single particle. In varnishes based on mixtures of latex and of Tolonate emulsion a high Young's modulus can nevertheless be obtained if the latex is hydroxylated (formulation 5 with latex H). Varnishes based on H and SC latex make it possible to obtain high mechanical performance (stress at break, Young's modulus, Persoz hardness on glass) without any significant decrease in the elongation at break (flexibility).

b) Behaviour Towards Solvent and Towards Water—Varnish Appearance.

| | Water | Swelling | |
|---|---|---|---|
| | uptake (%) | in solvent | Appearance of the |
| Formulation | after cure | after cure | varnishes on glass after |
| No. | (140° C.) | (140° C.) | cure (160° C.) |
| 1 | 0.2 | 11 | Transparent film |
| 2 | 1 | 8 | Transparent film |
| | | | (slight yellowing) |
| 3 | 5 | 2 | Transparent film |
| 4 | 15 | 5.5 | Cloudy scattering |
| | | | film |
| 5 | 2 | 3 | Transparent film |
| | | | (slight yellowing) |
| 6 | 10 | 2 | Clear, transparent, |
| | | | homogeneous film |
| 7 | — | — | Clear, transparent, |
| | | | homogeneous film |

Formulations 3, 6 and 5 yield the best property compromises. An adjusted content of reactive NCO functional groups enables the water resistance of the varnishes obtained to be greatly improved (formulation 5).

### EXAMPLE 8

Comparison of the reactivity (crosslinking kinetics at 160° C.) of formulations 5 and 6.

The change in the elastic modulus of the varnishes originating from formulations 5 and 6 is followed by DMA as a function of time according to the experimental procedure described in Example 6. The results are given in the table below:

| | Elastic modulus of the varnishes | | | | | | | |
|---|---|---|---|---|---|---|---|---|
| | (E′ × 10⁵ Pa) | | | | | | | |
| Formulation | Curing time at 160° C. (min) | | | | | | | |
| No. | 6 | 12 | 25 | 50 | 75 | 100 | 200 | 400 |
| 5 | 1.5 | 2 | 3 | 5 | 6 | 7 | 10 | 20 |
| 6 | 4 | 6 | 7.5 | 9 | 9.5 | 10 | 10 | 10 |

The kinetics of crosslinking of the self-crosslinkable varnish systems (based on latex SC1) are faster than those of the latex H+Tolonate emulsion mixtures. However, the latter system exhibits greater crosslinkability after an appropriate curing time (higher crosslinking density and higher elastic modulus).

1-29. (canceled)

30. A composition comprising a dispersion having at least one aqueous phase having a pH of between 4 and 9, a population of latex particles of polymer or of copolymer containing free carboxylic functional groups, free alcohol functional groups and masked isocyanate functional groups at the same time whose particles size is between 10 and 100 nanometers, wherein the particles have an accessible acidic functional group content, being the acidic functional groups, which are at most 5 nanometers from the surface of the particle-continuous aqueous phase interface, of between 0.2 and 1.2 milliequivalents/gram of solid matter, and an accessible alcoholic functional group content, being the hydroxyl functional groups, which are at most 10 nanometers from the surface of the particle-continuous aqueous phase interface and wherein said polymer or copolymer particles are originated from a copolymerization between at least one free acid monomer containing an activated ethylenic bond and at least one free alcohol, and, wherein a unit originating from said free alcohol monomer contains an activated ethylenic functional group which has a content of between 3 and 15% (mole).

31. The composition according to claim 30, wherein the ratio (equivalent) of the masked isocyanate functional groups to the alcohol functional groups is between 0.1 and 10.

32. The composition according to claim 31, wherein the ratio of the masked isocyanate functional groups to the alcohol functional groups is between 0.2 and 4.

33. The composition according to claim 30, wherein the ratio (equivalent) of the alcohol functional groups to the carboxylic functional groups is between 0.2 and 5.

34. The composition according to claim 30, wherein the ratio (equivalent) of the isocyanate functional groups to the carboxylic functional groups is between 0.2 and 4.

35. The composition according to claim 30, wherein the pH is between 4 and 9.

36. The composition according to claim 30, wherein the ratio (equivalent) of the masked isocyanate functional groups to the alcohol functional groups is between 0.1 and 10, the ratio (equivalent) of the alcohol functional groups to the carboxylic functional groups is between 0.2 and 5, and the ratio (equivalent) of the isocyanate functional groups to the carboxylic functional groups is between 0.2 and 4.

37. A process for the preparation of a coating comprising the steps of:
a) application onto a support of a composition according to claim 30 to obtain the coating on said support, and
b) curing said coating at a temperature of between 120 and 200° C.
